(19) United States
(12) Patent Application Publication
(10) Pub. No.: US 2009/0165880 A1
(43) Pub. Date: Jul. 2, 2009

(54) REFRIGERANT TRANSPORTATION HOSE AND METHOD OF PRODUCING THE SAME

(75) Inventor: Yuji TAKAGI, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/950,048

(22) Filed: Dec. 4, 2007

(30) Foreign Application Priority Data
Dec. 5, 2006 (JP) 2006-328514

(51) Int. Cl. F16L 11/04; B29C 43/46

(52) U.S. Cl. 138/137; 264/209.3; 138/141; 428/36.91

(57) ABSTRACT

A refrigerant transportation hose includes an innermost layer primarily of a polyamide resin, a low-permeability layer provided on the outer periphery of the innermost layer and made of polyvinyl alcohol, and a rubber layer (including an inner rubber layer and an outer rubber layer) provided on the outer periphery of the low-permeability layer. The innermost layer is formed with a multiplicity of through holes each extending in a direction of thickness of the innermost layer. The refrigerant transportation hose is produced by: extruding a material of the inner layer in the form of a hose to form a hose element; pressing a roll with spikes mounted on the surface thereof against an outer peripheral surface of the hose element to form in the hose element the multiplicity of through holes each extending in a direction of thickness of the hose element; and forming the low-permeability layer and the rubber layer (including the inner rubber layer and the outer rubber layer) in sequential order on the outer periphery of the hose element.

### BACKGROUND OF THE INVENTION

1. Field of the Invention

The present invention relates to a refrigerant transportation hose such as an air conditioner hose. More particularly, the invention relates to a refrigerant transportation hose for use in transporting a refrigerant (liquid or gas) including carbon dioxide (CO₂), chlorofluorocarbons (Freon), CFC substitutes, propane and the like and for use as a piping hose and the like in an automotive engine compartment and the like, and a method of producing the same.

2. Description of the Background Art

In general, an example of a refrigerant transportation hose for use as a piping hose in an automotive engine compartment includes a rubber hose in terms of the ease of assembly, the suppression of vibration transmission, flexibility and the like. As an example, there has been proposed a rubber hose configured to have a rubber inner layer in the form of a tube through which a refrigerant flows, a reinforcement layer formed on the outer peripheral surface of the inner layer, and a rubber outer layer formed on the outer peripheral surface of the reinforcement layer. Such a rubber hose is disclosed, for example, in Japanese Patent Application Laid-Open No. 7-68659 (1995).

Another hose which has an innermost hose layer made of a polyamide resin (PA) and a still another hose provided with metal foil and a laminate of evaporated metal have been proposed in order to suppress the penetration of a refrigerant such as chlorofluorocarbons (Freon) and CFC substitutes (R134a and the like) therethrough, i.e., to provide a better refrigerant-barrier property. Such hoses are disclosed, for example, in Japanese Patent Application Laid-Open No. 2001-241572.

Since fluorocarbons (Freon) which have been used as a refrigerant for an automotive air conditioner and the like lead to the destruction of the ozone layer in the atmosphere, the use of fluorocarbons (Freon) has already been banned. Moreover, CFC substitutes such as R134a and the like are becoming subject to future emission reductions. In view of the foregoing circumstances, a carbon dioxide (CO₂) refrigerant (liquid or gas) and a chemical refrigerant which have less adverse effect on the environment are considered to become predominant air conditioner refrigerants in the future.

The carbon dioxide refrigerant, however, is more penetrative than conventional refrigerants such as R134a, and penetrates through even a polyamide 6 (PA6) barrier layer which has been reliable for the conventional refrigerants. For this reason, the use of the conventional refrigerant transportation hose as the carbon dioxide refrigerant transportation hose results in the reduction in cooling performance. An attempt to provide a layer having a higher refrigerant-barrier property on the outer peripheral surface of the PA6 layer has also been contemplated. With such a layer arrangement, the carbon dioxide refrigerant penetrating through the PA6 layer accumulates between the above-mentioned two layers (the PA6 layer and the layer formed on the outer peripheral surface thereof). The accumulating carbon dioxide refrigerant expands during degassing (pressure reduction) for maintenance of the air conditioner to give rise to an apprehension about delamination, i.e., separation of the layers.

A hose provided with a laminate of metal foil and the like, on the other hand, is disadvantageous in that the laminate is prone to remove after prolonged use. This results in a problem such that the low permeability of the hose to a refrigerant gas is liable to become unstable.

### SUMMARY OF THE INVENTION

It is therefore an object of the present invention to provide a refrigerant transportation hose which is free of separation of layers, excellent in flexibility and excellent in low permeability to a refrigerant, and a method of producing the same.

According to a first aspect of the present invention, a refrigerant transportation hose comprises: an innermost layer consisting primarily of a polyamide resin; a low-permeability layer provided on the outer periphery of the innermost layer and made of polyvinyl alcohol; and a rubber layer provided on the outer periphery of the low-permeability layer, the innermost layer being formed with a multiplicity of through holes each extending in a direction of thickness of the innermost layer.

According to a second aspect of the present invention, a method of producing a refrigerant transportation hose comprises the steps of: extruding a material of an inner layer in the form of a hose to form a hose element; pressing a roll with spikes mounted on the surface thereof against an outer peripheral surface of the hose element to form in the hose element a multiplicity of through holes each extending in a direction of thickness of the hose element; and forming a low-permeability layer and a rubber layer in sequential order on the outer periphery of the hose element.

The present inventor has diligently studied to solve the above-mentioned problems. In the course of the study, it has been found that the formation of a layer using polyvinyl alcohol (PVOH) on the outer periphery of an innermost hose layer consisting primarily of a polyamide resin makes the hose excellent in low permeability to a refrigerant (particularly, a CO₂ refrigerant) even if the layer is thin. It has also been found out that the provision of a rubber layer on the outer periphery of the PVOH layer makes the hose excellent in vibrational absorption and in resistance to external mechanical shock. However, the hose having such a layer structure has exhibited a phenomenon such that delamination occurs at an interface of the PVOH layer and the innermost layer in some instances. After further studies for the investigation into the cause of the phenomenon, the present inventor has found that part of the refrigerant flowing in the hose penetrates through the innermost layer (the polyamide resin layer) to reach a PVOH layer surface, and is then interrupted thereat to accumulate at the interface between the innermost layer and the PVOH layer, resulting in the interface delamination. The formation of a multiplicity of through holes each extending in the direction of thickness of the innermost layer only in the innermost layer eliminates the accumulation of the refrigerant between the innermost layer and the PVOH layer. Thus, the present inventor has found that the delamination during degassing (pressure reduction) for maintenance of an air conditioner was avoided, and desired hose performance is achieved, thereby leading to the invention.

In this manner, the refrigerant transportation hose according to the present invention comprises the innermost layer consisting primarily of a polyamide resin, the low-permeability layer provided on the outer periphery of the innermost layer and made of polyvinyl alcohol, and the rubber layer provided on the outer periphery of the low-permeability layer. The refrigerant transportation hose is excellent in low permeability especially to a CO₂ refrigerant to suppress the reduction in cooling performance of the air conditioner and the like which results from refrigerant permeation. The innermost layer is formed with the multiplicity of through holes each extending in a direction of thickness of the innermost layer. This avoids the accumulation of the CO₂ refrigerant between the innermost layer and the low-permeability layer to prevent the delamination during degassing (pressure reduction) for maintenance of the air conditioner. Additionally, the refrigerant transportation hose according to the present invention, which is excellent in flexibility, is advantageous in piping and is advantageously used as a piping hose in an automotive engine compartment under severely vibrating conditions.

In particular, the refrigerant transportation hose in which the multiplicity of through holes formed in the innermost layer have an average diameter ranging from 10 to 100 μm eliminates the above-mentioned delamination and successfully provides low refrigerant permeation performance.

Additionally, the refrigerant transportation hose in which the low-permeability layer is formed by using polyvinyl alcohol having a degree of saponification of not less than 90% is excellent in low permeability to the refrigerant (especially the CO₂ refrigerant) even when the low-permeability layer is thin.

Further, the refrigerant transportation hose in which the low-permeability layer has a thickness ranging from 5 to 100 μm is more flexible.

Moreover, the refrigerant transportation hose in which the rubber layer on the outer periphery of the low-permeability layer is formed by using a butyl rubber is more excellent in low refrigerant permeability and in resistance to external water.

The method of producing a refrigerant transportation hose comprises the steps of: extruding a material of an inner layer in the form of a hose to form a hose element; pressing a roll with spikes mounted on the surface thereof (referred to hereinafter as a spiking roll) against an outer peripheral surface of the hose element to form in the hose element a multiplicity of through holes each extending in a direction of thickness of the hose element; and forming a low-permeability layer and a rubber layer in sequential order on the outer periphery of the hose element. This method achieves efficient production of the refrigerant transportation hose according to the present invention.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view showing an example of a refrigerant transportation hose according to the present invention;

FIG. 2 is a view illustrating a step of production of the refrigerant transportation hose according to the present invention; and

FIG. 3 is a perspective view of a hose element with a mandrel obtained by the step of production shown in FIG. 2.

### DESCRIPTION OF THE PREFERRED EMBODIMENTS

A preferred embodiment according to the present invention will now be described in detail.

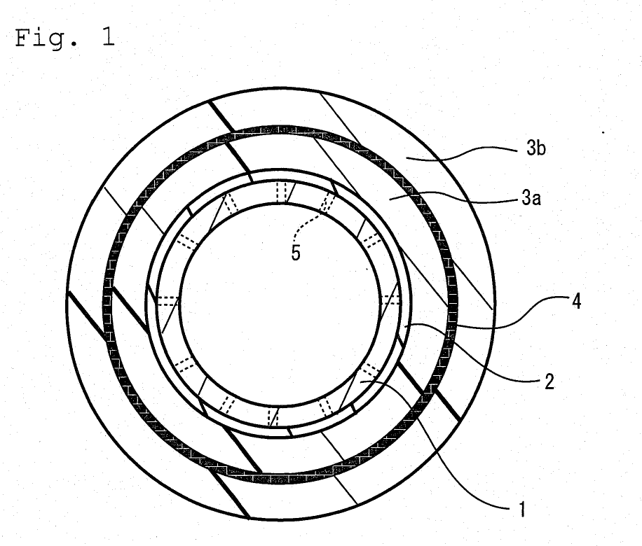

A refrigerant transportation hose according to the present invention includes an innermost layer 1, a low-permeability layer 2 provided on the outer periphery of the innermost layer 1, and a rubber layer (including an inner rubber layer 3a and an outer rubber layer 3b) provided on the outer periphery of the low-permeability layer 2, for example, as shown in FIG. 1. The innermost layer 1 is a layer consisting primarily of a polyamide resin, and the low-permeability layer 2 is a layer made of polyvinyl alcohol. The term “consisting primarily of” as used herein means that the constituent makes up at least 50% of all material of the innermost layer 1, and is to be interpreted as including meaning that the material consists only of the constituent. As illustrated, only the innermost layer 1 is formed with a multiplicity of through holes 5 extending in the direction of thickness of the innermost layer 1. Although the above-mentioned rubber layer is shown in FIG. 1 as having a double-layer structure including the inner rubber layer 3a and the outer rubber layer 3b, the structure of the rubber layer is not particularly limited. The rubber layer may be comprised of a single layer or at least three layers. The refrigerant transportation hose according to the present invention may further include a reinforcement layer 4, as appropriate, as shown in FIG. 1.

Examples of the polyamide resin for use as a material of the innermost layer 1 include polyamide 6 (PA6), polyamide 66 (PA66), polyamide 99 (PA99), polyamide 610 (PA610), polyamide 612 (PA612), polyamide 11 (PA11), polyamide 912 (PA912), polyamide 12 (PA12), a copolymer of polyamide 6 and polyamide 66 (PA6/66), a copolymer of polyamide 6 and polyamide 12 (PA6/12), and the like. These polyamide resins are used alone or in combination. Of these polyamide resins, polyamide 6 is preferably used because of its high layer-to-layer adhesion and its lower refrigerant permeability.

The material of the innermost layer 1 may contain an additive including a filler, a plasticizer, an antioxidant and the like, as appropriate, in addition to the polyamide resins.

As discussed above, polyvinyl alcohol (PVOH) is used as a material of the low-permeability layer 2 formed on the outer periphery of the innermost layer 1. Preferably, polyvinyl alcohol having a degree of saponification of not less than 90% is used. When the low-permeability layer 2 is prepared in the form of a thin layer, it is difficult for polyvinyl alcohol having a degree of saponification of less than 90% to obtain a desired level of low permeation performance especially to a carbon dioxide refrigerant. The degree of saponification of polyvinyl alcohol as represented by the formula:

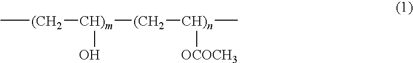

is determined by substituting the values of m and n in Formula (1) into

Degree of Saponification=[m/(m+n)]×100 (a)

The material of the low-permeability layer 2 is dissolved in water or alcohol (methanol, ethanol, isopropyl alcohol, and the like) for use as a coating liquid. In particular, water (hot water at a temperature of about 90° C. to about 95° C.) is preferably used as a solvent in terms of the solubility of the material of the low-permeability layer 2 therein. The coating liquid thus obtained preferably has a viscosity of 10 to 1000000 mPa·s at 25° C. in terms of forming the low-permeability layer 2 having no through holes and obtaining a good coating property (wettability and workability).

The material forming the rubber layer (including the inner rubber layer 3a and the outer rubber layer 3b) on the outer periphery of the low-permeability layer 2 is not particularly limited. An example of the material of the rubber layer is an appropriate mixture of a vulcanizing agent, carbon black and the like with a rubber material including halogenated butyl rubbers such as butyl rubber (IIR), chlorinated butyl rubber (Cl-IIR) and brominated butyl rubber (Br-IIR), acrylonitrile-butadiene rubber (NBR), chloroprene rubber (CR), ethylene-propylene-diene rubber (EPDM), ethylene-propylene rubber (EPM), fluoro-rubber (FKM), epichlorohydrin rubber (ECO), acrylic rubber, silicone rubber, chlorinated polyethylene rubber (CPE), urethane rubber, and the like. Of these rubber materials, butyl rubber (IIR) is preferably used because of its low refrigerant permeability and its high resistance to external water.

The rubber layer is shown in FIG. 1 as having a double-layer structure including the inner rubber layer 3a and the outer rubber layer 3b. When the rubber layer consists of a plurality of layers (at least two layers), the plurality of layers may be made of the same material or different materials. Additionally, the reinforcement layer 4 may be formed, as appropriate, as shown in FIG. 1. The reinforcement layer 4 is preferably placed between the inner rubber layer 3a and the outer rubber layer 3b, as shown, because such an arrangement makes the function of the reinforcement layer 4 sufficiently effective. The reinforcement layer 4 may be formed by spiraling, knitting, braiding or otherwise weaving of a reinforcement yarn made of, for example, polyethylene terephthalate (PET), polyethylene naphthalate (PEN), aramid, polyamide (nylon), vinylon, rayon, and metal wire.

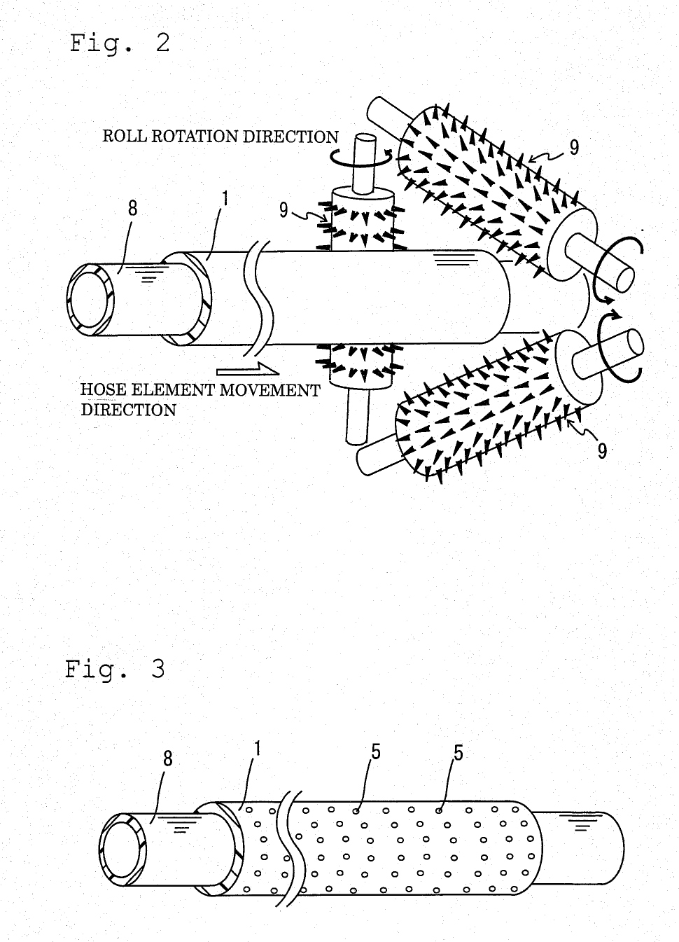

The refrigerant transportation hose according to the present invention as shown in FIG. 1 is produced, for example, in a manner to be described below, although the method of producing the refrigerant transportation hose is not particularly limited. First, the material of the innermost layer 1 discussed above is prepared. Next, a mandrel 8 is used, as shown in FIG. 2, to extrude the above-mentioned material of the innermost layer 1 in the form of a hose thereonto, thereby forming a tubular hose element (or the innermost layer 1). Spiking rolls 9 are pressed against the outer peripheral surface of the hose element (or the innermost layer 1). Then, each of the spiking rolls 9 is rotated in a roll rotation direction shown in FIG. 2, and the hose element is moved in a direction indicated by the outline arrow shown in FIG. 2. This forms a multiplicity of through holes 5 in succession in the hose element (or the innermost layer 1), as shown in FIG. 3. Thereafter, the low-permeability layer 2, the rubber layer and the like are formed in sequential order on the outer periphery of the hose element. This achieves the production of an intended refrigerant transportation hose. It should be noted that the above-mentioned mandrel 8 is used, as required. The three spiking rolls 9 are shown in FIG. 2 as pressed against the side surface of the hose element from three directions. However, the method of forming the through holes 5 is not limited to this method.

Preferably, the average diameter of the multiplicity of through holes formed in the innermost layer 1 is set within the range of 10 to 100 μm. The pitch of the through holes (or a distance between adjacent ones of the through holes) is set within the range of 10 to 100 mm. Setting the average diameter and pitch of the through holes within such ranges successfully solves the problem of delamination resulting from the accumulation of the refrigerant between the innermost layer 1 and the low-permeability layer 2, and also successfully provides the low refrigerant permeation performance. The through holes having an average diameter exceeding 200 μm might cause a burst starting from the through holes (pinhole burst) under a low pressure.

The low-permeability layer 2 is formed by preparing the material thereof (or the coating liquid) and coating the outer peripheral surface of the innermost layer 1 with the material. This coating method is not particularly limited, but conventional methods including dipping, spraying, roll coating, brushing and the like may be applied to the coating method. After the coating, a drying process is performed to form the low-permeability layer 2 having no through holes. After the low-permeability layer 2 is formed in this manner, the rubber layer is extruded onto the outer periphery of the low-permeability layer 2, and the reinforcement layer 4 is formed, as required. (In FIG. 1, after the inner rubber layer 3a is formed, the reinforcement layer 4 is formed on the outer peripheral surface of the inner rubber layer 3a, and thereafter the outer rubber layer 3b is formed on the outer peripheral surface of the reinforcement layer 4.) Thus, the refrigerant transportation hose having an intended layer structure is produced.

Prior to the formation of the low-permeability layer 2, etching processes including ultraviolet irradiation, plasma treatment, corona discharge and the like may be performed on the outer peripheral surface of the innermost layer 1 as the process of surface preparation for adhesion. Of these etching processes, the plasma treatment is preferably used to roughen the outer peripheral surface of the innermost layer 1 in terms of improvement in layer-to-layer adhesion, following which the low-permeability layer 2 is formed directly on the roughened surface.

Prior to the formation of the low-permeability layer 2, an adhesive layer may be formed on the outer peripheral surface of the innermost layer 1. The material of the adhesive layer is not particularly limited, but may be, for example, a rubber cement adhesive, an urethane adhesive, a polyester adhesive, an isocyanate adhesive, an epoxy adhesive and the like. These adhesives are used alone or in combination. Of these adhesives, the rubber cement adhesive is preferably used because of its high layer-to-layer adhesion between the innermost layer 1 and the low-permeability layer 2.

The refrigerant transportation hose according to the present invention preferably has a hose inside diameter ranging from 5 to 40 mm. The innermost layer 1 preferably has a thickness ranging from 0.02 to 2.0 mm.

The low-permeability layer 2 preferably has a thickness ranging from 5 to 100 μm. The low-permeability layer 2 having a thickness of less than 5 μm is poor in low refrigerant permeability. On the other hand, the low-permeability layer 2 having a thickness of greater than 100 μm is rigid and presents some difficulty in the flexibility of the hose to give rise to an apprehension about the occurrence of a crack in the hose.

The thickness of the rubber layer formed on the outer periphery of the low-permeability layer 2 is not particularly limited. However, when the rubber layer has a double-layer structure including the inner rubber layer 3a and the outer rubber layer 3b as shown in FIG. 1, the inner rubber layer 3a preferably has a thickness ranging from 0.5 to 5 mm, and the outer rubber layer 3b preferably has a thickness ranging from 0.5 to 2.0 mm.

The refrigerant transportation hose according to the present invention is preferably used as a hose for transporting a refrigerant including carbon dioxide (CO₂) chlorofluorocarbons, CFC substitutes, propane and the like for use in an air conditioner radiator and the like. More preferably, the refrigerant transportation hose according to the present invention is used as a hose for transporting a carbon dioxide refrigerant. The refrigerant transportation hose is preferably used not only in automotive vehicles but also in other transporting machines (industrial transport vehicles such as an airplane, a forklift, a power shovel or excavator and a crane, and railway vehicles).

Next, inventive examples will be described in conjunction with comparative examples. It should be noted that the present invention is not limited to the inventive examples to be described below.

### Example 1

PA6 (NYLON 6 1030B manufactured by Ube Industries, Ltd.) was extruded in the form of a hose onto a mandrel (having an outside diameter of 8 mm) made of TPX (a synthetic resin) to form a tubular inner most layer (having a thickness of 0.15 mm). Next, plasma treatment was performed on the outer peripheral surface of the innermost layer to roughen the outer peripheral surface of the innermost layer. Subsequently, spiking rolls (manufactured by Tokai Rubber Industries, Ltd.) were pressed against the outer peripheral surface of the innermost layer from three directions, as shown in FIG. 2, and were rotated in the directions indicated by arrows shown in FIG. 2. At the same time, the innermost layer was moved together with the mandrel in a direction indicated by the outline arrow shown in FIG. 2. Thus, a multiplicity of through holes (having an average diameter of 10 μm and a pitch of 10 mm) were formed in succession in the innermost layer. Thereafter, an adhesive layer (having a thickness of 10 μm) made of a rubber cement adhesive was formed on the outer peripheral surface of the innermost layer, and the adhesive layer was coated by dipping with a coating liquid (having a viscosity of 500 mPa·s at 25° C.) obtained by dissolving polyvinyl alcohol (PVOH) (GOHSENOL N-300 manufactured by Nippon Synthetic Chemical Industry Co., Ltd. and having a degree of saponification of 99%) in hot water at 90° C. A laminated hose element thus obtained was placed into and dried in a drying oven. Thus, a low-permeability layer (having a thickness of 10 μm) having no through holes was formed. An inner rubber layer (having a thickness of 1.6 mm) was formed on the outer periphery of the low-permeability layer by the extrusion of a butyl rubber. Thereafter, a reinforcement layer was formed on the outer peripheral surface of the inner rubber layer by braiding of an aramid yarn. Further, an outer rubber layer (having a thickness of 1.0 mm) was formed on the outer peripheral surface of the reinforcement layer by the extrusion of EPDM. After vulcanization, the mandrel was removed from the laminated hose element, and the extruded part of a continuous length was cut. Thus, an intended refrigerant transportation hose was produced (See FIG. 1).

### Example 2

A refrigerant transportation hose was produced in the same manner as Example 1, except that the low-permeability layer (or the PVOH layer) having a thickness of 100 μm was formed.

### Example 3

A refrigerant transportation hose was produced in the same manner as Example 1, except that the low-permeability layer (or the PVOH layer) having a thickness of 5 μm was formed.

### Example 4

A refrigerant transportation hose was produced in the same manner as Example 1, except that PVOH having a degree of saponification of 90% (GOHSENOL AH-17 manufactured by Nippon Synthetic Chemical Industry Co., Ltd.) was used as the PVOH for forming the low-permeability layer (or the PVOH layer) and that the low-permeability layer (or the PVOH layer) having a thickness of 5 μm was formed.

### Example 5

A refrigerant transportation hose was produced in the same manner as Example 1, except that the spiking rolls were adjusted so that the through holes formed in the innermost layer had an average diameter of 10 μm and a pitch of 100 mm.

### Example 6

A refrigerant transportation hose was produced in the same manner as Example 1, except that the spiking rolls were adjusted so that the through holes formed in the innermost layer had an average diameter of 100 μm and a pitch of 100 mm.

### Example 7

A refrigerant transportation hose was produced in the same manner as Example 1, except that the spiking rolls were adjusted so that the through holes formed in the innermost layer had an average diameter of 100 μm and a pitch of 150 mm.

### Example 8

A refrigerant transportation hose was produced in the same manner as Example 1, except that the spiking rolls were adjusted so that the through holes formed in the innermost layer had an average diameter of 200 μm and a pitch of 100 mm.

### Comparative Example 1

A refrigerant transportation hose was produced in the same manner as Example 1, except that the low-permeability layer (or the PVOH layer) was not formed and that the through holes in the innermost layer were not formed by the spiking rolls.

### Comparative Example 2

A refrigerant transportation hose was produced in the same manner as Example 1, except that the through holes in the inner most layer were not formed by the spiking rolls.

Characteristics of the hoses thus produced according to Examples 1 through 8 and Comparative Examples 1 and 2 were evaluated in accordance with criteria to be described below. The results of the evaluation were presented in Tables 1 and 2 below. The dashes in Tables 1 and 2 indicate that the corresponding characteristics were not evaluated.

### [CO₂ Permeability]

With CO₂ sealed in a hose at a low temperature (−35° C. or below), stoppers were placed in openings formed on opposite ends of the hose, and the hose was allowed to stand in an oven held at 90° C. The amount of CO₂ reduction in the hose with time was plotted, and the amount of CO₂ permeation per day (a CO₂ permeability coefficient in units of mg·mm/cm²·day) for the permeation area of the hose was calculated from the slope of the plots. The amount of CO₂ permeation was represented by an index relative to the measured value of the amount of CO₂ permeation of an article produced in Comparative Example 1 in which the PVOH layer was not formed, assuming that the measured value is 100. For the CO₂ permeability, an example having the above-mentioned index of less than 50 was evaluated as being “good” (indicated by an open circle), and an example having the above-mentioned index of greater than 50 was evaluated as being “unacceptable” (indicated by a cross).

### [Film Formation]

The coating film formation during the dipping of the PVOH layer was visually evaluated. An example in which the coating film surface did not shed the coating liquid and no bubbles were formed on the coating film surface was evaluated as being “good” (indicated by an open circle).

In Examples and Comparative Examples, cracking was evaluated in a tube obtained prior to the formation of the inner rubber layer, the reinforcement layer and the outer rubber layer (i.e., a tube with the low-permeability layer (or the PVOH layer) formed and dried on the outer periphery of the innermost layer (PA6 layer)). Specifically, an example in which anomalies such as cracks and delamination were not found in the low-permeability layer (or the PVOH layer) after the tube was bent at an angle of 90 degrees was evaluated as being “good” (indicated by an open circle).

### [Delamination]

With CO₂ sealed in the hose at a low temperature (−35° C. or below), stoppers were placed in openings formed on opposite ends of the hose, and the hose was allowed to stand in an oven held at 90° C. After 24 hours, the hose was taken out of the oven, and the stoppers in the openings formed on opposite ends of the hose were removed to release CO₂ from the hose quickly. Thereafter, the hose was cut into halves which in turn were checked for the delamination of the PA6 layer and the PVOH layer. An example in which the delamination was detected was evaluated as being “unacceptable” (indicated by a cross). An example in which the delamination was detected slightly but presented no problem was evaluated as being “relatively poor but acceptable” (indicated by a triangle). An example in which the delamination was not detected was evaluated as being “good” (indicated by an open circle).

### [Pressure-Resistance of Hose (Resistance to Pinhole Burst)]

The hose was mounted in a hose burst tester, and hydraulic pressure was applied to the hose at a rate of rise of 160 MPa per minute until the hose burst. An example in which the bursting pressure of the hose in this test was not greater than 40 MPa was evaluated as being “relatively poor but acceptable” (indicated by a triangle). An example in which the bursting pressure was greater than 40 MPa was evaluated as being “good” (indicated by an open circle).

TABLE 1

| | | Examples | | | | Comparative |
|---|---|---|---|---|---|---|
| | | 1 | 2 | 3 | 4 | Example 1 |
| CO₂ | Index | 9 | 9 | 15 | 25 | 100 |
| Permeability | Evaluation | ◯ | ◯ | ◯ | ◯ | X |

| | | | | | |
|---|---|---|---|---|---|
| Film Formation | ◯ | ◯ | ◯ | ◯ | — |
| Cracking | ◯ | ◯ | ◯ | ◯ | — |

TABLE 2

| | Examples | | | | | Comparative |
|---|---|---|---|---|---|---|
| | 1 | 5 | 6 | 7 | 8 | Example 2 |
| Delamination | ◯ | ◯ | ◯ | Δ | ◯ | X |
| Pressure-Resistance | ◯ | ◯ | ◯ | ◯ | Δ | ◯ |
| of Hose | | | | | | |

The foregoing results show that articles produced according to Examples are significantly reduced in CO₂ permeability as compared with an article produced according to Comparative Example 1. The articles produced according to Examples avoided the delamination resulting from the accumulation of the CO₂ refrigerant between the innermost layer and the low-permeability layer. It has been shown by experiment that a method performed according to Examples efficiently produces a good hose according to Examples as described above.

The refrigerant transportation hose according to the present invention is preferably used as a hose for transporting a refrigerant including carbon dioxide (CO₂), chlorofluorocarbons, CFC substitutes, propane and the like for use in an air conditioner radiator and the like.

While the invention has been described in detail, the foregoing description is in all aspects illustrative and not restrictive. It is understood that numerous other modifications and variations can be devised without departing from the scope of the invention.

What is claimed is:

1. A refrigerant transportation hose comprising:
an innermost layer comprising primarily a polyamide resin;
a low-permeability layer provided on the outer periphery of said innermost layer and made of polyvinyl alcohol; and
a rubber layer provided on the outer periphery of said low-permeability layer,
said innermost layer being formed with a multiplicity of through holes each extending in a direction of thickness of said innermost layer.

2. The refrigerant transportation hose according to claim 1, wherein said multiplicity of through holes formed in said innermost layer have an average diameter ranging from 10 to 100 μm.

3. The refrigerant transportation hose according to claim 1, wherein said low-permeability layer is formed by using polyvinyl alcohol having a degree of saponification of not less than 90%.

4. The refrigerant transportation hose according to claim 1, wherein said low-permeability layer has a thickness ranging from 5 to 100 μm.

5. The refrigerant transportation hose according to claim 1, wherein said rubber layer is formed by using a butyl rubber.

6. The refrigerant transportation hose according to claim 1, said refrigerant transportation hose being a hose for transporting a carbon dioxide (CO₂) refrigerant.

7. A method of producing the refrigerant transportation hose according to claim 1, comprising the steps of:
extruding a material of an inner layer in the form of a hose to form a hose element;
pressing a roll with spikes mounted on the surface thereof against an outer peripheral surface of said hose element to form in said hose element a multiplicity of through holes each extending in a direction of thickness of said hose element; and
forming a low-permeability layer and a rubber layer in sequential order on the outer periphery of said hose element.
